(19) United States
(12) Patent Application Publication
(10) Pub. No.: US 2007/0116918 A1
(43) Pub. Date: May 24, 2007

(54) Method for inducing a visible light response in a material

(75) Inventors: Valery Victor Belov, Allentown, NJ (US); Howard Y. Bell, Princeton, NJ (US); Victoria Ann Bell, Princeton, NJ (US); Tatyana Belov, Allentown, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Sunstone Technology, Inc., Allentown, NJ (US)

(21) Appl. No.: 11/285,936

(22) Filed: Nov. 23, 2005

(51) Int. Cl. B32B 3/02

(52) U.S. Cl. 428/64.4; 313/498; 427/157; 283/92; 428/690; 428/195.1

(57) ABSTRACT

A method for inducing a visible light response in a material comprising combining an up-conversion phosphor, which emits visible light wavelengths when stimulated by non-coherent infrared wavelengths, with the material and activating the phosphor with a source that emits non-coherent infrared wavelengths to produce a visible-light response in the material.

### BACKGROUND OF THE INVENTION

Phosphors are materials which absorb energy and release the absorbed energy in the form of electromagnetic radiation, most typically as visible light. Where the phosphor absorbs energy from electromagnetic radiation impinging on the phosphor this radiation may be referred to as “exciting” radiation. Where the absorbed energy is released immediately, the phenomenon is known as “fluorescence.” For example, a material which exhibits fluorescence may emit visible light while excited by ultraviolet light impinging upon the material.

Where the energy of the exciting electromagnetic radiation is stored within the phosphor and released in response to additional electromagnetic radiation, referred to as “stimulating” radiation, the phenomenon is referred to as “stimulated emission.” For example, a phosphor exhibiting the behavior referred to as stimulated emission may be exposed to ultraviolet radiation, and exhibit no appreciable glow after the ultraviolet exposure. However, when this phosphor is treated with infrared stimulating radiation, it may emit substantial quantities of visible light. The term “luminescence” includes all of these phenomena, as well as other phenomena involving absorption of energy within a material and release of that energy as electromagnetic radiation, most typically, but not necessarily, as visible light. The term “phosphor” thus includes all luminescent materials.

Phosphors can be categorized in accordance with their behavior as fluorescent, phosphorescent, or stimulable. A “stimulable” phosphor is one which, at room temperature, stores energy absorbed upon exposure to exciting electromagnetic radiation and releases the predominant portion of the stored energy upon exposure to stimulating electromagnetic radiation. A phosphorescent phosphor at room temperature will store absorbed energy for an appreciable time but will release the predominant portion of the stored energy spontaneously. A fluorescent phosphor will release the predominant portion of the absorbed energy as emission radiant energy substantially simultaneously with exposure to the exciting radiant energy.

Phosphors can be utilized in a wide variety of scientific and industrial applications, such as markers for authentic, non-counterfeit items. However, methods for exciting and recognizing phosphors through the use of ultraviolet light are generally not appropriate for non-technical or consumer use since such methods require the use of expensive ultraviolet light sources, which most consumers do not already own. Further, improper use of ultraviolet light sources by untrained users may pose health risks associated with ultraviolet light. Therefore, a need exists for a method of using phosphors for exposing hidden features in a material with minimal use of artificial ultraviolet light sources.

### SUMMARY OF THE INVENTION

This need is met by the present invention.

A method is disclosed for providing and revealing a hidden feature in a material via a visible light response in the material. The method comprises combining an up-conversion phosphor, which emits visible light wavelengths when stimulated by non-coherent infrared wavelengths, with the material and activating the phosphor with a source that emits non-coherent infrared wavelengths to produce a visible-light response in the material.

In a preferred embodiment, the visible light wavelengths emitted by the up-conversion phosphor are visible to the human eye under ambient conditions.

In a preferred embodiment, the phosphor is a phosphor stimulable by non-coherent infrared wavelengths having (a) an alkaline earth sulfur selenium crystalline matrix, wherein the alkaline-earth metal is selected from strontium, calcium and combinations thereof, wherein the molar ratio of S to Se is between about 1:10 and 10:1; (b) Eu as a first activator in an amount of about 5 to about 500 ppm by weight based on the weight of the matrix; and (c) Bi, Sm or combinations thereof, as a second activator each in an amount of about 5 to about 500 ppm by weight based on the weight of the matrix, the activators being dispersed within said matrix, said matrix and said activators cooperatively defining active sites adapted to store energy upon exposure of the phosphor to visible or ultraviolet light, said active sites being adapted to emit said stored energy as visible light upon exposure of the phosphor to non-coherent infrared light, said phosphor including at least about 5×10¹⁷ of said active sites per cm³ and having a stimulation quantum efficiency of at least 5 percent.

In another embodiment, the source is a remote control device for an electronic device such as, for example, a household remote control device for controlling a television set, CD player, or DVD player. In yet another embodiment, the remote control device emits non-coherent infrared radiation having a wavelength from about 700 nm to about 2000 nm, preferably from about 750 nm to about 1000 nm. In one embodiment, the material is selected from paper, board, metal, wood, leather, plastic and textiles.

In another embodiment, the phosphor is combined with the material by printing a composition containing the phosphor on the material or extruding the phosphor with the material. The printing method can be selected from gravure printing, flexographic printing, screen printing, offset printing, continuous inkjet printing, and dropwise inkjet printing.

In one embodiment, the material is incorporated into an item subject to counterfeiting. In a specific embodiment, the item is selected from compact discs, DVDs, cigarettes, textiles, negotiable securities such as stock certificates, security documents, and currency. In another embodiment, the visible-light response indicates an authentic item.

In an additional embodiment, the material is incorporated into a game piece or lottery or prize ticket. In a specific embodiment, the visible-light response indicates a winning game piece or lottery or prize ticket.

Another embodiment includes incorporating the material into a text, such as a book, pamphlet, or other printed article. In a specific embodiment, a visible-light response in the material incorporated into the text reveals a hidden feature.

In one embodiment, the material is incorporated into a multiple-choice format. In a specific embodiment, a visible-light response in the multiple-choice format indicates a correct answer.

Additional embodiments include a compact disc, a negotiable securities certificate, a lottery, prize, or game ticket, or printed text in a book having an up-conversion phosphor, which emits visible light when stimulated by non-coherent infrared wavelengths. In further embodiments, the up-conversion phosphor is printed on these items by a printing method selected from the group consisting of gravure printing, flexographic printing, screen printing, offset printing, continuous inkjet printing, and dropwise inkjet printing.

### BRIEF DESCRIPTION OF THE DRAWINGS

FIG. 1a illustrates the authentication of a compact disc by stimulating an up-conversion phosphor with non-coherent infrared wavelengths emitted by a remote control device;

FIG. 1b illustrates the authentication of currency by stimulating an up-conversion phosphor with non-coherent infrared wavelengths emitted by a remote control device;

FIG. 2a illustrates stimulating an up-conversion phosphor incorporated into a printed text in a book with non-coherent infrared wavelengths emitted by a remote control device; and

FIG. 2b illustrates stimulating an up-conversion phosphor incorporated into a multiple-choice format with non-coherent infrared wavelengths emitted by a remote control device.

### DETAILED DESCRIPTION OF THE PREFERRED EMBODIMENTS

The present invention is based upon the use of stimulable phosphors to emit light of relatively short wavelengths, such as visible light, upon stimulation with non-coherent light of relatively long wavelengths, such as infrared light, which is referred to as “up-conversion” or “anti-stokes” conversion.

The method of the present invention comprises combining an up-conversion phosphor with a material to provide a hidden feature in the material and activating the phosphor with a source that emits non-coherent infrared wavelengths to produce a visible-light response in the material to reveal the hidden feature.

Preferred visible light wavelengths emitted by the up-conversion phosphor include wavelengths that are visible to the human eye under ambient conditions.

A preferred up-conversion phosphor is an infrared stimulable phosphor capable of being stimulated by non-coherent infrared wavelengths such as the phosphors disclosed in U.S. Pat. No. 4,857,228, the contents of which are incorporated herein by reference. The preferred stimulable phosphor has (a) an alkaline earth sulfur selenium crystalline matrix, wherein the alkaline-earth metal is selected from strontium, calcium and combinations thereof, wherein the molar ratio of S to Se is between about 1:10 and 10:1; (b) Eu as a first activator in an amount of about 5 to about 500 ppm by weight based on the weight of the matrix; and (c) Bi, Sm or combinations thereof, as a second activator each in an amount of about 5 to about 500 ppm by weight based on the weight of the matrix, the activators being dispersed within said matrix, said matrix and said activators cooperatively defining active sites adapted to store energy upon exposure of the phosphor to visible or ultraviolet light, said active sites being adapted to emit said stored energy as visible light upon exposure of the phosphor to infrared light, said phosphor including at least about 5×10¹⁷ of said active sites per cm³ and having a stimulation quantum efficiency of at least 5 percent. However, any phosphor capable of up-converting non-coherent infrared light to visible light may be used.

The infrared wavelength source can be a remote control device for an electronic device, such as any household remote control device that emits a non-coherent infrared signal. Such remote control devices include, but are not limited to, those for televisions, VCRs, DVD players, stereos, and ceiling fans. Remote control devices specifically made to reveal the phosphors may also be used. A preferred remote control device emits non-coherent infrared radiation having a wavelength from about 700 nm to about 2000 nm, more preferably from about 750 nm to about 1000 nm. The material marked with the up-conversion phosphor can be any material suitable for marking, such as paper, board, metal, wood, leather, plastic and textiles.

The up-conversion phosphor can be combined with the material alone or while incorporated into a carrier. The up-conversion phosphor can be combined with the material by printing the phosphor on the material or extruding the phosphor with the material. The printing method can be selected from gravure printing, flexographic printing, screen printing, offset printing, continuous inkjet printing, and dropwise inkjet printing.

The method of the present invention can be used whenever it is necessary for a consumer to reveal a feature in a material that is hidden until revealed after exposure to non-coherent infrared wavelengths. One specific use includes the incorporation of the up-conversion phosphor and the material into an item subject to counterfeiting wherein the visible-light response indicates an authentic item. Such items include, but are not limited to, compact discs, DVDs, cigarettes, textiles, negotiable securities such as stock certificates, security documents, such as negotiable securities certificates, and currency.

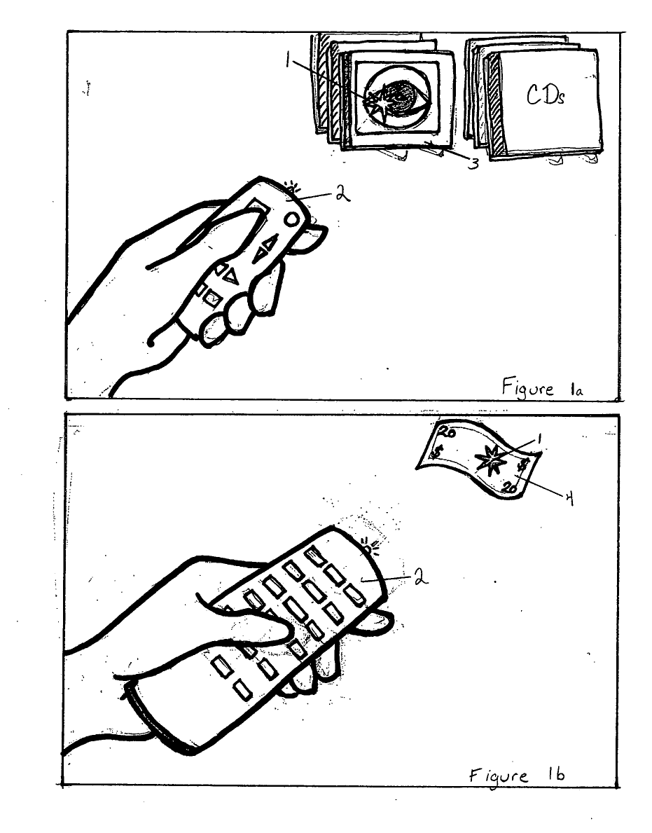

For example, FIGS. 1a and 1b depict visible-light response 1 produced by stimulating the up-conversion phosphor (not shown) with non-coherent infrared wavelengths (not shown) emitted by remote control device 2 to authenticate a compact disc 3 and currency 4, respectively.

Another method involves incorporating the up-conversion phosphor and material into a game piece or lottery or prize ticket. For example, the consumer might remove the game piece or lottery or prize ticket from protective packaging that obscures the game portion prior to distribution to the consumer. After removing the game piece or lottery or prize ticket from the protective packaging, the consumer proceeds to expose the game portion to non-coherent infrared wavelengths emitted by a remote control device, wherein a visible-light response indicates a winning game piece or lottery or prize ticket. Alternatively, the visible-light response could indicate a pattern on the game piece or lottery or prize ticket that is not necessarily a winner or might reveal a message such as, “Sorry, not a winner” or similar phrase.

Another method includes incorporating the up-conversion phosphor and material into a text, such as a book, magazine, pamphlet and the like. For example, the phosphor could be printed on a page in a book or on the cover. A visible-light response from the up-conversion phosphor would reveal a hidden feature, such as a picture, a phrase, or a character in a story.

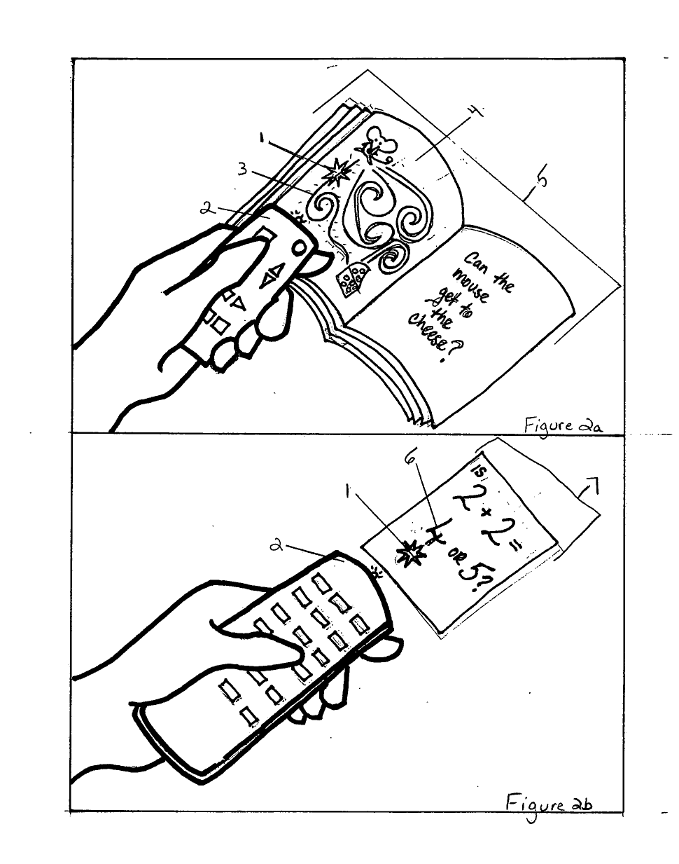

For example, FIG. 2a depicts visible-light response 1 produced by stimulating the up-conversion phosphor (not shown) with non-coherent infrared wavelengths (not shown) emitted by remote control device 2 to indicate correct maze 3 printed on page 4 of book 5.

The phosphor and material could also be incorporated into a multiple-choice format. For example, questions could be printed with conventional ink while the answer choices are printed with conventional ink and the up-conversion phosphor. After reading the question the consumer selects an answer. The correctness of the answer choices is evaluated by exposing the answers to non-coherent infrared wavelengths emitted by a remote control device. A visible-light response indicates the correct answer.

For example, FIG. 2b depicts visible-light response 1 produced by stimulating the up-conversion phosphor (not shown) with non-coherent infrared wavelengths (not shown) emitted by remote control device 2 to indicate correct answer 6 in multiple-choice format 7.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

What is claimed is:

1. A method for inducing a visible light response in a material comprising combining an up-conversion phosphor, which emits visible light wavelengths when stimulated by non-coherent infrared wavelengths, with the material, and activating the phosphor with a source that emits non-coherent infrared wavelengths to produce a visible-light response in the material.

2. The method of claim 1, wherein the phosphor comprises an infrared stimulable phosphor consisting essentially of:
(a) an alkaline earth sulfur selenium crystalline matrix, wherein the alkaline-earth metal selected from the group consisting of strontium, calcium and combinations thereof, wherein the molar ratio of S to Se is between about 1:10 and 10:1;
(b) Eu as a first activator in an amount of about 5 to about 500 ppm by weight based on the weight of the matrix; and
(c) Bi, Sm or combinations thereof, as a second activator each in an amount of about 5 to about 500 ppm by weight based on the weight of the matrix,
said activators being dispersed within said matrix, said matrix and said activators cooperatively defining active sites adapted to store energy upon exposure of the phosphor to visible or ultraviolet light, said active sites being adapted to emit said stored energy as visible light upon exposure of the phosphor to infrared light, said phosphor including at least about 5×10¹⁷ of said active sites per cm³ and having a stimulation quantum efficiency of at least 5 percent.

3. The method of claim 1, wherein the source comprises a household remote control device for controlling an electronic device.

4. The method of claim 3, wherein said electronic device is a television set, CD player, or DVD player.

5. The method of claim 1, wherein the material is selected from the group consisting of paper, board, metal, wood, leather, plastic and textiles.

6. The method of claim 1, wherein the phosphor is combined with the material by printing the phosphor on the material or extruding the phosphor with the material.

7. The method of claim 6, wherein the printing method is selected from the group consisting of gravure printing, flexographic printing, screen printing, offset printing, continuous inkjet printing, and dropwise inkjet printing.

8. The method of claim 1, wherein the material is incorporated into an item subject to counterfeiting.

9. The method of claim 8, wherein the item is selected from the group consisting of compact disks, DVDs, cigarettes, textiles, negotiable securities, security documents, and currency.

10. The method of claim 8, wherein the visible-light response indicates an authentic item.

11. The method of claim 1, further comprising incorporating the material into a game piece or lottery or prize ticket.

12. The method of claim 11, wherein the visible-light response indicates a winning game piece or lottery or prize ticket.

13. The method of claim 1, further comprising incorporating the material into a printed text.

14. The method of claim 13, wherein the visible-light response reveals a hidden feature.

15. The method of claim 13, further comprising incorporating the material into a multiple-choice format.

16. The method of claim 15, wherein the visible-light response indicates a correct answer.

17. In combination, an article subject to counterfeiting and an authentication means comprising an up-conversion phosphor, which emits visible light when stimulated by non-coherent infrared wavelengths.

18. The combination of claim 17, wherein the article subject to counterfeiting is a compact disc.

19. The combination of claim 16, wherein the article subject to counterfeiting is currency or a negotiable securities certificate.

20. A lottery, prize, or game ticket comprising an up-conversion phosphor, which emits visible light when stimulated by non-coherent infrared wavelengths emitted by a remote control device.

21. The lottery prize or game ticket of claim 20, wherein said phosphor is printed thereon by a printing method selected from the group consisting of gravure printing, flexographic printing, screen printing, offset printing, continuous inkjet printing, and dropwise inkjet printing.

22. A printed text comprising an up-conversion phosphor, which emits visible light when exposed to non-coherent infrared wavelengths.

23. The printed text of claim 22, wherein said text is part of a book, pamphlet, or magazine.

24. The printed text of claim 22, wherein said phosphor is printed thereon by a printing method selected from the group consisting of gravure printing, flexographic printing, screen printing, offset printing, continuous inkjet printing, and dropwise inkjet printing.

25. The method of claim 1, wherein said visible light response is visible to the human eye under ambient conditions.

26. The method of claim 1, wherein said non-coherent infrared wavelengths are from about 700 nm to about 2000 nm.

27. The method of claim 26, wherein said non-coherent infrared wavelengths are from about 750 nm to about 1000 nm.
